(19) United States
(12) Patent Application Publication
(10) Pub. No.: US 2018/0259663 A1
(43) Pub. Date: Sep. 13, 2018

(54) SYSTEM AND METHOD FOR EARTH IMAGING USING NEAR FIELD HYDROPHONE DATA

(71) Applicant: CHEVRON U.S.A. INC., San Ramon, CA (US)

(72) Inventor: Kevin John Davies, London (GB)

(21) Appl. No.: 15/905,929

(22) Filed: Feb. 27, 2018

Related U.S. Application Data
(60) Provisional application No. 62/468,100, filed on Mar. 7, 2017.

(51) Int. Cl. G01V 1/34; G01V 1/38; G01V 1/30

(52) U.S. Cl. CPC G01V 1/345; G01V 1/302; G01V 1/308; G01V 1/3808

(57) ABSTRACT

A method is described for processing Near Field Hydrophone (NFH) data including time or depth imaging for 3D and 4D high resolution geological interpretation. The method may include various combinations of source-NFH configurations, such as one or more NFH's mounted on both firing and or non-firing source arrays and source energy generated by cumulative air guns or air gun clusters firing on the active source array and/or individual air guns or air gun clusters firing on the active source array, whether fired simultaneously or non-simultaneously. The method may be executed by a system.

### CROSS-REFERENCE TO RELATED APPLICATIONS

This application claims the benefit of U.S. Provisional Patent Application 62/468100 filed Mar. 7, 2017.

### STATEMENT REGARDING FEDERALLY SPONSORED RESEARCH OR DEVELOPMENT

Not applicable.

### TECHNICAL FIELD

The disclosed embodiments relate generally to techniques for seismic imaging of the Earth's subsurface and, in particular, to a method for high resolution imaging of geologic features using seismic data from near field hydrophone data.

### BACKGROUND

Seismic exploration involves surveying subterranean geological media for hydrocarbon deposits. A survey typically involves deploying seismic sources and seismic sensors at predetermined locations. The sources generate seismic waves, which propagate into the geological medium creating pressure changes and vibrations. Variations in physical properties of the geological medium give rise to changes in certain properties of the seismic waves, such as their direction of propagation and other properties.

Portions of the seismic waves reach the seismic sensors. Some seismic sensors are sensitive to pressure changes (e.g., hydrophones), others to particle motion (e.g., geophones), and industrial surveys may deploy one type of sensor or both. In response to the detected seismic waves, the sensors generate corresponding electrical signals, known as traces, and record them in storage media as seismic data. Seismic data will include a plurality of “shots” (individual instances of the seismic source being activated), each of which are associated with a plurality of traces recorded at the plurality of sensors.

In marine surveys, the seismic sources may be an array (e.g., air guns) pulled by a vessel. In general, the seismic data used for seismic imaging is recorded by seismic sensors pulled by the same or other vessels in the form of Towed Streamers (TS), by Ocean Bottom Sensors (OBS), or by Vertical Seismic Profile (VSP) sensors in the water column or down hole.

Near Field Hydrophones (NFH) are commonly deployed on marine seismic source arrays for air gun performance quality control and estimation of Notional Sources for far field signature estimation and subsequent source signature deconvolution (Ziolkowski et. al.,1982; Kragh et. al., 2000). NFH data are not currently acquired as a separate or additional imaging tool to conventional TS, OBS or VSP data.

Seismic data is processed to create seismic images that can be interpreted to identify subsurface geologic features including hydrocarbon deposits. The ability to define the location of rock and fluid property changes in the subsurface is crucial to our ability to make the most appropriate choices for purchasing materials, operating safely, and successfully completing projects. Project cost is dependent upon accurate prediction of the position of physical boundaries within the Earth. Decisions include, but are not limited to, budgetary planning, obtaining mineral and lease rights, signing well commitments, permitting rig locations, designing well paths and drilling strategy, preventing subsurface integrity issues by planning proper casing and cementation strategies, and selecting and purchasing appropriate completion and production equipment.

There exists a need for improved cost effective, high resolution, frequent seismic imaging of geologic features including overburden and hydrocarbon reservoirs.

### SUMMARY

In accordance with some embodiments, a method of processing Near Field Hydrophone (NFH) data including time or depth imaging for 3D and 4D high resolution geological interpretation is disclosed. The method may include various combinations of source to NFH configurations, such as one or more NFH's mounted on firing and or non-firing array while individual airgun, or air gun clusters or air gun sub-array or airgun array or air gun arrays are actively firing.

In another aspect of the present invention, to address the aforementioned problems, some embodiments provide a non-transitory computer readable storage medium storing one or more programs. The one or more programs comprise instructions, which when executed by a computer system with one or more processors and memory, cause the computer system to perform any of the methods provided herein.

In yet another aspect of the present invention, to address the aforementioned problems, some embodiments provide a computer system. The computer system includes one or more processors, memory, and one or more programs. The one or more programs are stored in memory and configured to be executed by the one or more processors. The one or more programs include an operating system and instructions that when executed by the one or more processors cause the computer system to perform any of the methods provided herein.

### BRIEF DESCRIPTION OF THE DRAWINGS

FIGS. 1a and 1b illustrate an arrangement of seismic sources and receivers, in accordance with some embodiments;

FIGS. 2a-2d illustrate combinations of seismic source-receiver data, in accordance with some embodiments;

FIGS. 3a-3c illustrate Common Mid Point (CMP) locations for different combinations of seismic source-receiver data including multiple sail lines, in accordance with some embodiments;

FIGS. 4a-4h illustrate seismic images obtained, in accordance with some embodiments;

FIGS. 5a-5f illustrate seismic images obtained, in accordance with some embodiments; and

FIGS. 6a-6c illustrate seismic images obtained, in accordance with some embodiments.

Like reference numerals refer to corresponding parts throughout the drawings.

### DETAILED DESCRIPTION OF EMBODIMENTS

Described below are methods, systems, and computer readable storage media that provide a manner of seismic imaging. These embodiments are designed to be of particular use for seismic imaging of subsurface volumes in geologically complex areas.

Reference will now be made in detail to various embodiments, examples of which are illustrated in the accompanying drawings. In the following detailed description, numerous specific details are set forth in order to provide a thorough understanding of the present disclosure and the embodiments described herein. However, embodiments described herein may be practiced without these specific details. In other instances, well-known methods, procedures, components, and mechanical apparatus have not been described in detail so as not to unnecessarily obscure aspects of the embodiments.

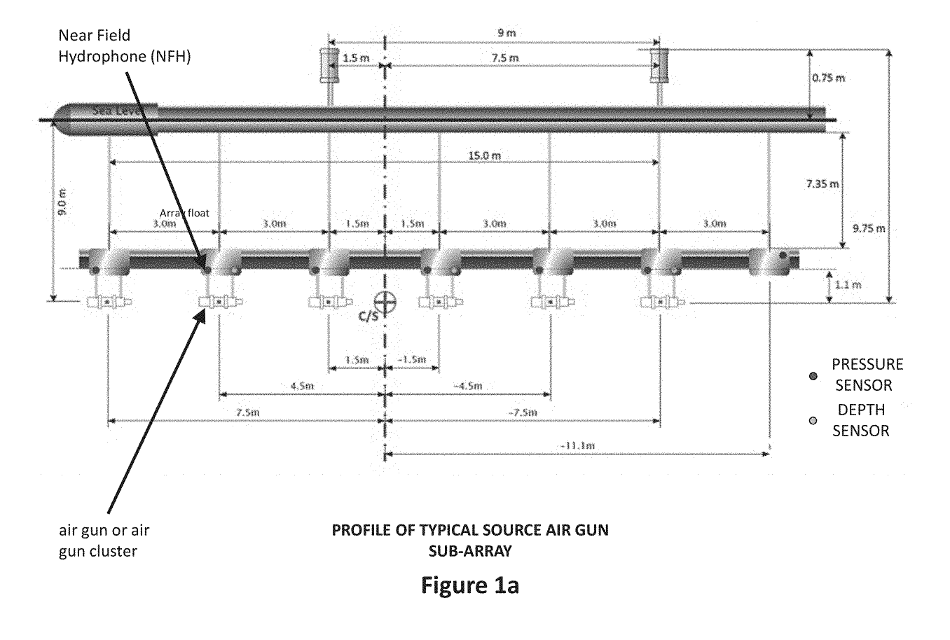

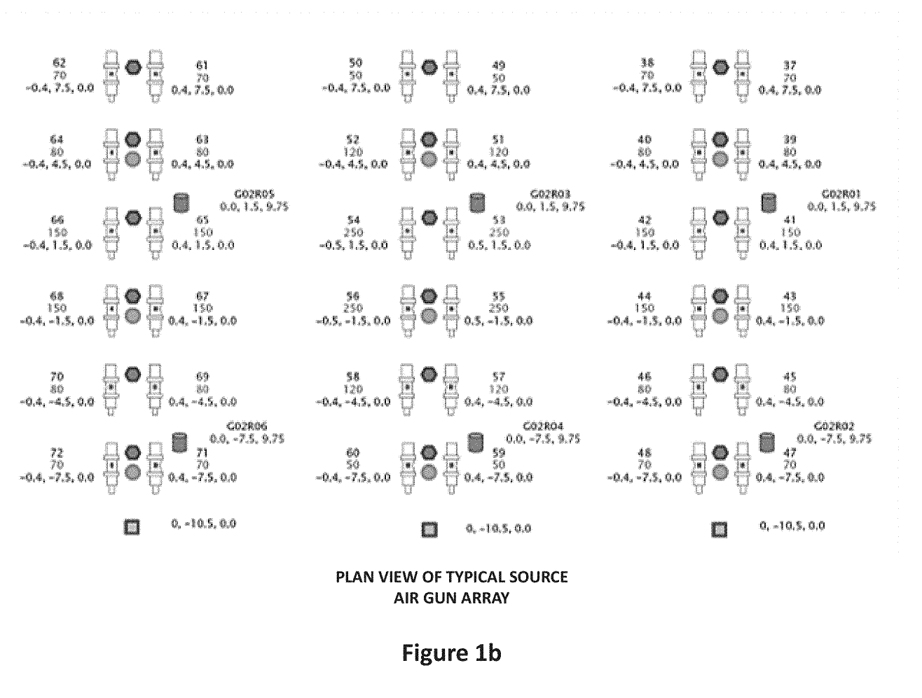

Seismic time or depth imaging of the subsurface is used to identify geologic features including shallow features and potential hydrocarbon reservoirs. Seismic data may be acquired in a marine survey in which a vessel pulls one or more source arrays and the same or other vessel pulls one or more receivers (TS) and/or receivers may be located on the ocean bottom (OBS) or suspended in the water column or down hole (VSP). Additionally, the source array may include one or more Near Field Hydrophones (NFH) located on or near the source arrays, as indicated in FIGS. 1a and 1b. The recorded seismic traces collectively make up the seismic dataset.

The present invention includes embodiments of a method and system for seismic time and depth imaging using the NFH data. The present invention makes use of NFH data as a standalone or alternative time or depth imaging tool using both single source arrays or multiple firing and non-firing source arrays (e.g. dual flip flop or more than two source configurations) to form earth time or depth images from each source air gun or air gun cluster or full air gun array to each NFH receiver, both on firing and non-firing air guns.

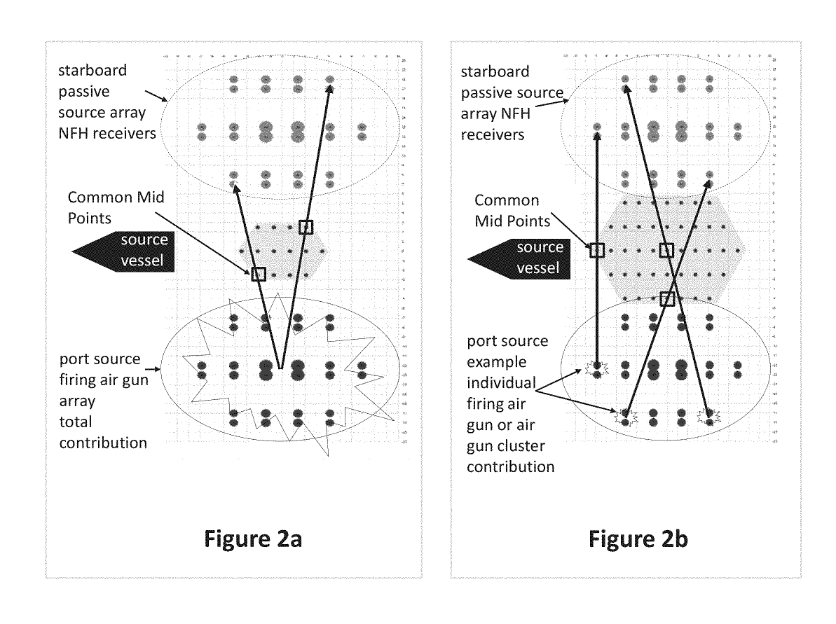

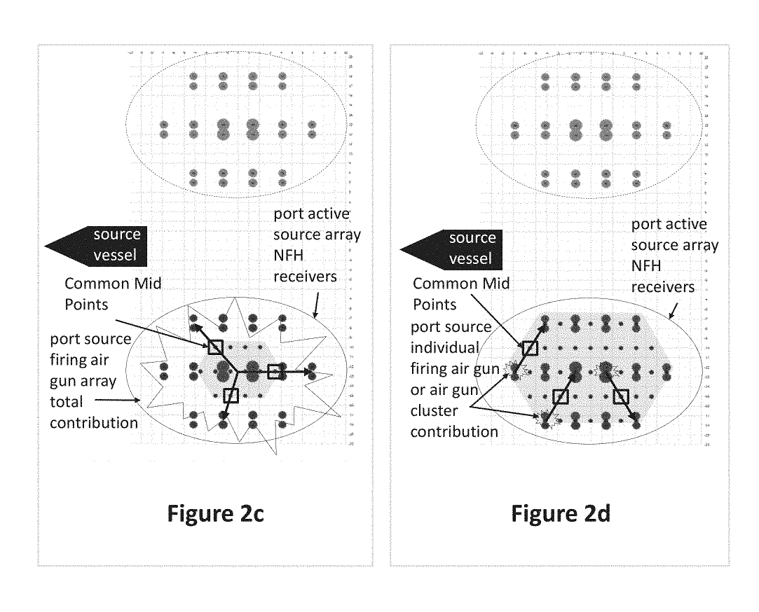

FIG. 2a shows one combination of source-receiver NFH data. All air gun or air gun clusters in port source array fire (simultaneously or non-simultaneously), the combined array seismic energy travels both directly and via sub-surface and is recorded by each NFH on passive starboard array. Sub-surface Common Mid Point (CMP) image locations are shown. CMP locations indicate approximate locations that can be time or depth imaged using the recorded data.

FIG. 2b shows another combination of source-receiver NFH data. Each individual air gun or air gun cluster on Port source array fires (simultaneously or non-simultaneously), the individual air gun or air gun cluster seismic energy travels both directly and via sub-surface and recorded by each NFH on passive starboard array. CMP locations indicate approximate locations that can be time or depth imaged using the recorded data.

FIG. 2c shows another combination of source-receiver NFH data. Each air gun or air gun cluster on port source array fires (simultaneously or non-simultaneously), the combined array seismic energy travels both directly and via sub-surface and recorded by each NFH on firing port array. The CMP locations indicate approximate locations that can be time or depth imaged using the recorded data.

FIG. 2d shows another combination of source-receiver NFH data. Each air gun or air gun cluster on port source array fires (simultaneously or non-simultaneously), the individual air gun or air gun cluster seismic energy travels both directly and via sub-surface and recorded by each NFH on firing port array. CMP locations indicate approximate locations that can be time or depth imaged using the recorded data.

In some embodiments, the recorded NFH data may be processed to separate each individual air gun or air gun cluster. In particular, the NFH data may be used to calculate notional sources and then each gun or cluster may be deconvolved in turn based on the notional sources. This process may optionally be performed in an iterative manner in order to optimize the separation. The separated data may then be used for further processing including imaging.

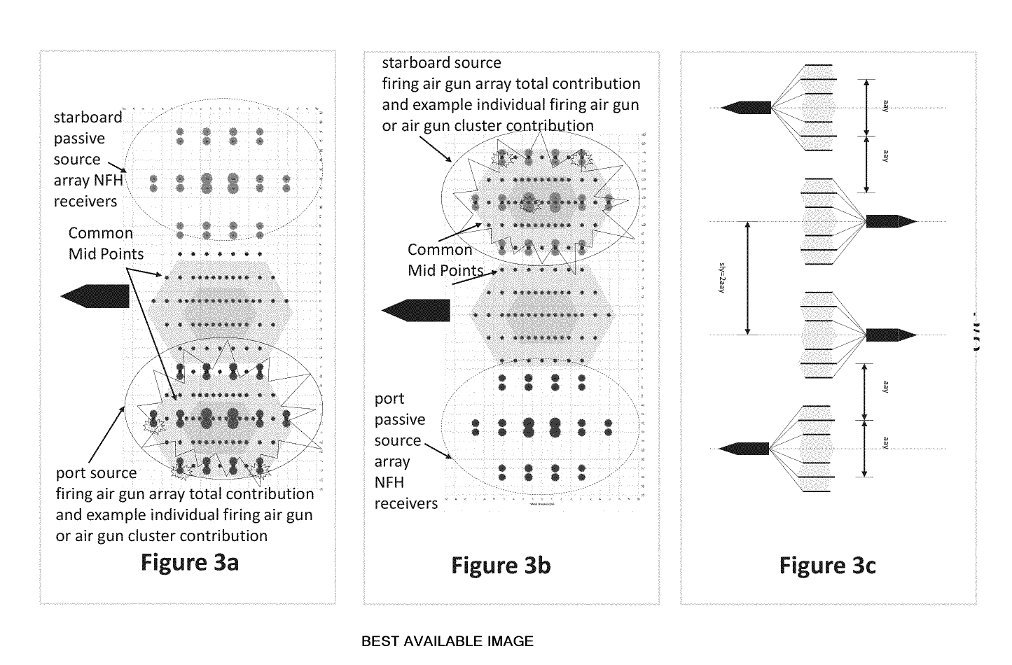

FIG. 3a shows cumulative CMP image locations available for firing port total source array and individual air gun or air gun clusters as recorded by NFH on passive starboard array.

FIG. 3b shows cumulative CMP image locations available for starboard total source array and individual air gun or air gun clusters as recorded by NFH on passive port array.

FIG. 3c shows cumulative CMP coverage of FIGS. 3a and 3b for multiple source vessel sail paths and how these can be used to build up image coverage.

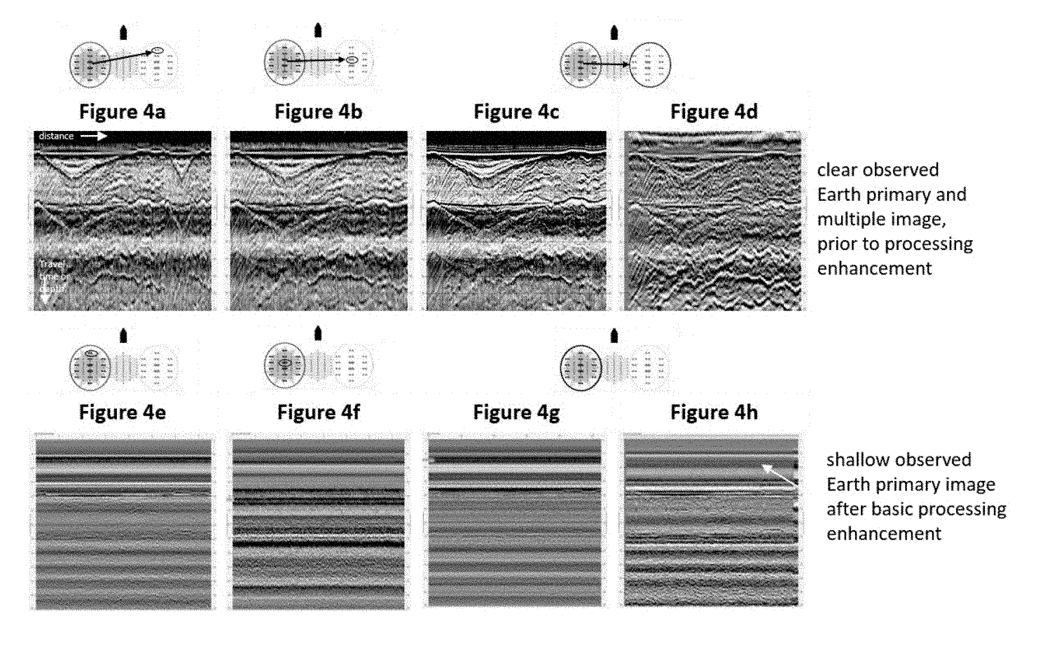

FIGS. 4a, 4b show observed data examples from a sail line of shots, from individual port firing air gun clusters into different starboard passive NFH receivers on the non-firing array with similar geometry to that described in FIG. 2a. FIG. 4c shows the summed response from all non-firing NFH array data recorded with similar geometry to that described in FIG. 2a. FIG. 4d shows a 2D migrated image from the summed passive starboard array NFH receivers. Primary Earth reflection and multiple are clearly observed.

FIGS. 4e, 4f show observed data examples from a sail line of shots, from individual port firing air gun clusters into different NFH receivers on the firing array with similar geometry to that described in FIG. 2c. FIG. 4g shows the summed response from all firing NFH array data recorded with similar geometry to that described in FIG. 2c. FIG. 4h shows a 2D migrated image from the summed active port array NFH receivers. Despite only basic spectral whitening, Primary Earth reflection and multiple are clearly observed. The horizontal striping is dominantly residual source bubble energy to be processed as signal or removed as noise. Handling the residual source bubble energy correctly is particularly important for single source surveys. Those of skill in the art will appreciate that there are several known methods for handling the residual source bubble energy such as filtering.

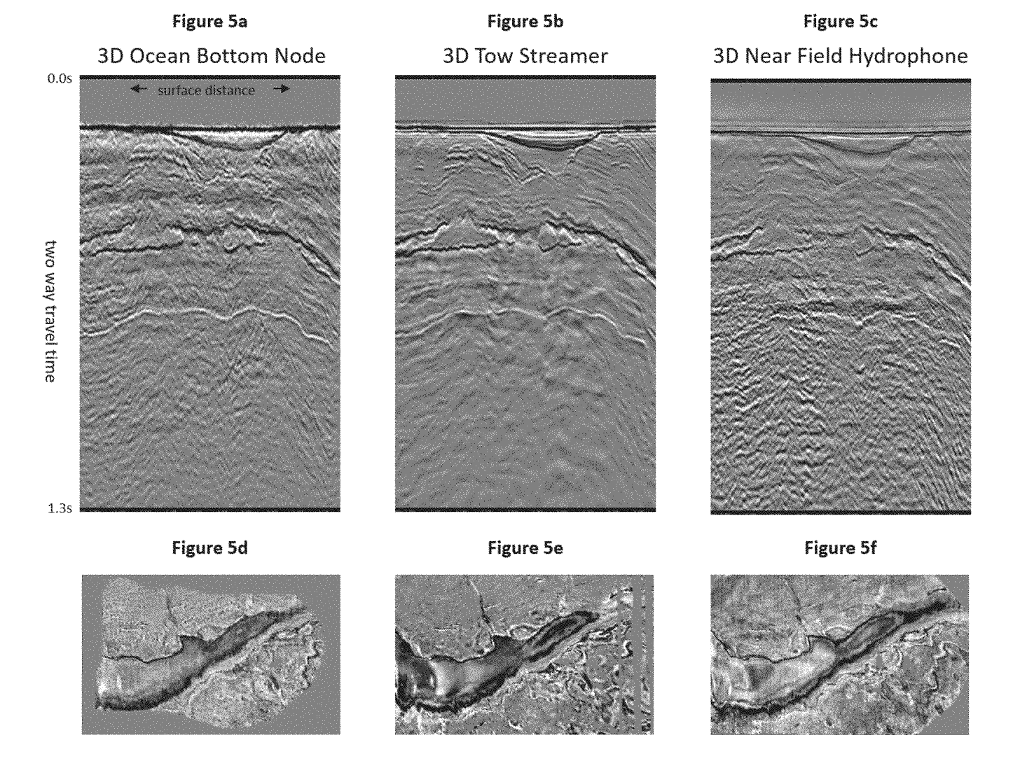

FIGS. 5a, 5b show observed 3D seismic sections acquired over the same approximate location with OBN and TS methods respectively. FIG. 5c shows the same area imaged with 3D NFH. FIGS. 5d, e and f show the corresponding time slice map views. The NFH image is comparable and includes enhanced shallow resolution compared to OBN and TS.

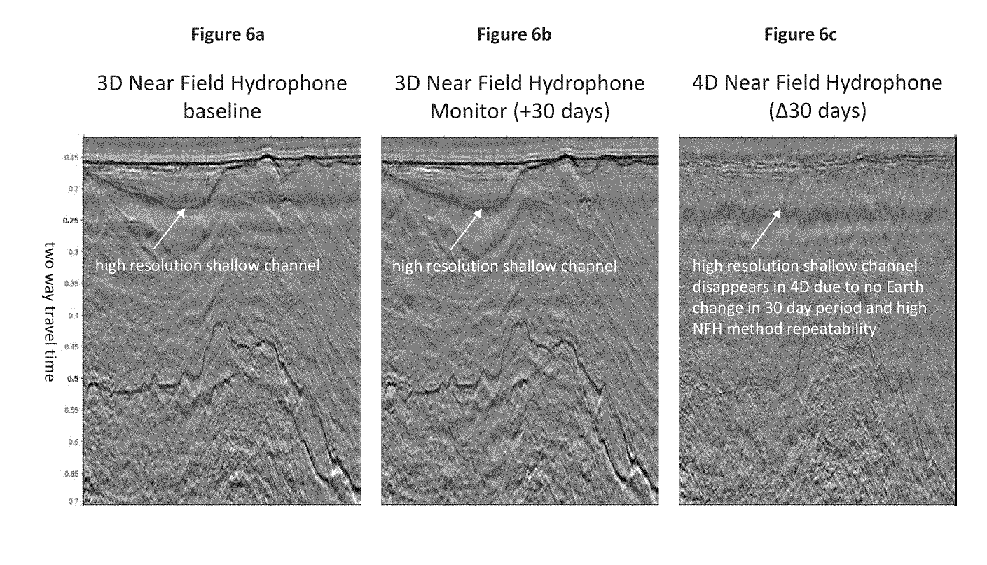

FIGS. 6a, 6b show observed narrow swath 3D NFH seismic sections acquired approximately 30 days apart to evaluate NFH suitability for 4D. FIG. 6c shows the 4D time lapse or change between the two surveys. While there is 4D environmental noise, some source generated related noise, the high resolution shallow channel is mostly absent from the 4D section, demonstrating the high repeatability of the NFH method and suitability for high resolution 4D monitoring.

Source to NFH data, commonly recorded in typical 2D, 3D, 4D (time lapse) TS, OBS and VSP surveys, enable low cost, efficient time and depth imaging for use in high resolution water bottom, overburden, and reservoir monitoring, either as a substitute or in addition to time and depth imaging by traditional TS, OBS and VSP receiver data. The method makes use of conventional source arrays and NFH equipment.

While particular embodiments are described above, it will be understood it is not intended to limit the invention to these particular embodiments. On the contrary, the invention includes alternatives, modifications and equivalents that are within the spirit and scope of the appended claims. Numerous specific details are set forth in order to provide a thorough understanding of the subject matter presented herein. But it will be apparent to one of ordinary skill in the art that the subject matter may be practiced without these specific details. In other instances, well-known methods, procedures, components, and circuits have not been described in detail so as not to unnecessarily obscure aspects of the embodiments.

The terminology used in the description of the invention herein is for the purpose of describing particular embodiments only and is not intended to be limiting of the invention. As used in the description of the invention and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, operations, elements, and/or components, but do not preclude the presence or addition of one or more other features, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

Although some of the various drawings illustrate a number of logical stages in a particular order, stages that are not order dependent may be reordered and other stages may be combined or broken out. While some reordering or other groupings are specifically mentioned, others will be obvious to those of ordinary skill in the art and so do not present an exhaustive list of alternatives. Moreover, it should be recognized that the stages could be implemented in hardware, firmware, software or any combination thereof.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

### REFERENCES

Ziolkowski, A. M., Parkes, G. E. Hatton, L., and Haugland, T., 1982. A method for calculating the output pressure waveform from an airgun. Geophysics 47, 2067-2079.

Kragh, E., Laws, R. and Özbek, A., Source signature estimation: attenuation of the sea-bottom reflection error from near-field measurements. , Geophysical Prospecting First Break 18:6, 260-264, 2000

US Patent Application No. US 2011/0063947

U.S. Pat. No. 8,958,266

What is claimed is:

1. A computer-implemented method of seismic imaging, comprising:
a. receiving, at a computer processor, a seismic dataset representative of a subsurface volume of interest, wherein the seismic dataset was recorded by at least one Near Field Hydrophone (NFH), and wherein the at least one NFH was mounted on at least one of firing source arrays and non-firing source arrays and source energy was generated by cumulative sources on the firing source array or individual sources on the firing source array, and wherein the firing source arrays or the individual sources are fired simultaneously or non-simultaneously;
b. migrating the seismic dataset to create a digital high resolution seismic image; and
c. identifying geologic features based on the digital high resolution seismic image.

2. The method of claim 1 further comprising additional data processing prior to migrating.

3. The method of claim 1 wherein the migrating is one of time migration or depth migration.

4. The method of claim 1 wherein the seismic dataset is 3D or 4D.

5. A system for seismic imaging, comprising:
one or more processors;
memory; and
one or more programs, wherein the one or more programs are stored in the memory and configured to be executed by the one or more processors, the one or more programs including instructions that when executed by the one or more processors cause the device to execute
a. receiving, at a computer processor, a seismic dataset representative of a subsurface volume of interest, wherein the seismic dataset was recorded by at least one Near Field Hydrophone (NFH), and wherein the at least one NFH was mounted on at least one of firing source arrays and/or non-firing source arrays and source energy was generated by cumulative sources on the firing source array or individual sources on the firing source array, and wherein the firing source arrays or the individual sources are fired simultaneously or non-simultaneously;
b. migrating the seismic dataset to create a digital high resolution seismic image; and
c. identifying geologic features based on the digital high resolution seismic image.

6. A non-transitory computer readable storage medium storing one or more programs, the one or more programs comprising instructions, which when executed by an electronic device with one or more processors and memory, cause the device to execute
a. receiving, at a computer processor, a seismic dataset representative of a subsurface volume of interest, wherein the seismic dataset was recorded by at least one Near Field Hydrophone (NFH), and wherein the at least one NFH was mounted on at least one of firing source arrays and non-firing source array and source energy was generated by cumulative sources on the firing source array or individual sources on the firing source array, and wherein the firing source arrays or the individual sources are fired simultaneously or non-simultaneously;
b. migrating the seismic dataset to create a digital high resolution seismic image; and
c. identifying geologic features based on the digital high resolution seismic image.
